(19) United States
(12) Patent Application Publication
(10) Pub. No.: US 2018/0070777 A1
(43) Pub. Date: Mar. 15, 2018

(54) LOCKING ASSEMBLY FOR A REMOVABLE HANDLE

(71) Applicant: Hy Cite Enterprises, LLC, Madison, WI (US)

(72) Inventors: Aric Dichraff, Madison, WI (US); Lu Shen, Johnson Creek, WI (US); Craig Stevenson, Fitchburg, WI (US); Chor Leung Ko, Sha Tin (HK); Chi Wai Chan, Tuen Mun (HK); Shang Xin Yan, Yunfu (CN); Jian Ming Qiu, Foshan (CN); Guan Xun OU, Yunfu (CN)

(21) Appl. No.: 15/261,213

(22) Filed: Sep. 9, 2016

(51) Int. Cl. A47J 45/07

(52) U.S. Cl. CPC A47J 45/071

(57) ABSTRACT

A detachable handle assembly includes a handle configured to removably engage a portion of the cookware, and a locking assembly carried by the handle. The locking assembly includes a push button operably connected to a locking member. The locking assembly is configured to selectively engage the portion of the cookware in response to actuation of the push button.

### FIELD OF THE INVENTION

The present invention relates to a selectively removable handle for a pot, pan, or other cookware. More specifically, the present invention relates to a locking assembly that is configured to selectively lock the removable handle to the cookware.

### BACKGROUND

Cookware with a non-removable handle is generally known in the art. A handle provides a user with a convenient way to carry, hold, or otherwise move the cookware. Unfortunately, such cookware has limitations. For example, the non-removable handle extends a distance away from the cookware, taking up a substantial amount of storage space (e.g., kitchen cabinets, etc.) and/or area of use (e.g., stove tops, ovens, etc.). In addition, cookware with non-removable handles has limitations as to the material that can be used to form the handle. For example, some non-removable handles are formed of a metallic material to allow for use on a stovetop and in an oven. However, when this cookware is heated, the non-removable handle also becomes hot. This hot handle can lead to burns on a user's hand. To attempt to address this hot handle issue, other cookware forms the non-removable handle out of a material that limits heat transfer from the cookware to the handle (e.g., a polymer, etc.). Unfortunately, this handle material can have a lower melting temperature, meaning the cookware cannot be used in an oven or in certain high temperature environments.

Other cookware attempts to address these issues by providing a removable handle. Unfortunately, these known removable handles do not include any lock, which can lead to unintentional detachment of the handle from the cookware. Unintentional detachment can cause undesirable results, including food waste and user injury. For example, unintentional detachment of the handle while the user carries cookware that contains hot food can lead to user injury (e.g., burns, etc.) and food waste (e.g., due to spilling of the food). Accordingly, there is a need for cookware that can provide a removable handle for cookware that includes a reliable, yet simple way to lock the handle to the cookware to avoid unintentional handle detachment.

### SUMMARY

In one embodiment, the disclosure provides a detachable handle assembly for cookware that includes a handle configured to removably engage a portion of the cookware, and a locking assembly carried by the handle. The locking assembly includes a push button operably connected to a locking member, the locking member being configured to selectively engage the portion of the cookware in response to actuation of the push button.

In another embodiment, the disclosure provides a detachable handle assembly for cookware that includes a handle configured to removably engage a portion of the cookware, a first locking subassembly carried by the handle and configured to selectively engage the portion of the cookware in response to actuation of a portion of the first locking assembly, and a second locking subassembly carried by the handle and configured to restrict actuation of the first locking subassembly.

In another embodiment, the disclosure provides a method of selectively attaching a handle to an article of cookware that includes positioning the handle into engagement with a portion of the cookware, and engaging a locking member to the portion of the cookware in response to actuating a push button.

Other aspects of the invention will become apparent by consideration of the detailed description and accompanying drawings.

### BRIEF DESCRIPTION OF THE DRAWINGS

FIG. 1 is a perspective view of an embodiment of a piece of cookware that includes a plurality of removable handles in an attached configuration.

FIG. 2 is a perspective view of the cookware of FIG. 1 with each of the removable handles in a detached configuration.

FIG. 3 is an exploded view of a first embodiment of a locking assembly of one of the removable handles of FIG. 1.

FIG. 4 is a cross-section view of a portion of the handle, taken along line 4-4 of FIG. 2, and illustrating the first embodiment of the locking assembly positioned in the handle and in a locked configuration, the handle being detached from the cookware.

FIG. 5 is a perspective view of a locking collar separated from the second locking assembly, and taken along line 5-5 of FIG. 3.

FIG. 6 is a perspective view of a push button of the locking assembly, taken along line 6-6 of FIG. 3 and illustrating a channel system.

FIG. 7 is a perspective view of one of a portion of the handle, taken along line 7-7 of FIG. 3, and illustrating a handle locking assembly receiving aperture.

FIG. 8 is a perspective view of one of a portion of the handle, taken along line 8-8 of FIG. 7, and further illustrating the handle locking assembly receiving aperture.

FIG. 9A is an end view of the handle, taken along line 9-9 of FIG. 2, and illustrating the handle locking assembly is a locked configuration.

FIG. 9B is an end view of the handle, taken along line 9-9 of FIG. 2, and illustrating the handle locking assembly is an unlocked configuration.

FIG. 10 is a flow diagram of a method of engaging one of the removable handles of FIG. 1 with a piece of cookware, and further operating the handle locking assembly of FIG. 3 to selectively lock the handle to the cookware.

FIG. 11 is a perspective view of one of the removable handles assemblies of FIG. 1, illustrating the removable handle being positioned into engagement with the cookware, a first locking subassembly being in the unlocked configuration and a second locking subassembly being in a locked configuration.

FIG. 12 is a perspective view of the removable handle of FIG. 11, illustrating the removable handle positioned into engagement with the cookware.

FIG. 13 is a perspective view of the removable handle of FIG. 12, illustrating the second locking subassembly being positioned into an unlocked configuration.

FIG. 14 is a perspective view of the removable handle of FIG. 13, illustrating the first locking subassembly being positioned into a locked configuration to lock the handle to the cookware.

FIG. 15 is a perspective view of the removable handle of FIG. 14, illustrating the second locking subassembly being positioned into a locked configuration, locking actuation of the first locking subassembly.

FIG. 16 is an exploded view of a second embodiment of a locking assembly of one of the removable handles of FIG. 1.

FIG. 17 is a perspective view of the cookware of FIG. 1 with one of the removable handles in a detached configuration, and each of the removable handles carrying another example of an embodiment of the handle locking assembly.

FIG. 18 is an exploded view of a second embodiment of the locking assembly of one of the removable handles of FIG. 16.

FIG. 19 is a cross-section view of a portion of the handle, taken along line 19-19 of FIG. 17, and illustrating the second embodiment of the locking assembly positioned in the handle and in an unlocked configuration, the handle being detached from the cookware.

FIG. 20 is a perspective view of the removable handle of FIG. 17, illustrating the removable handle positioned into engagement with the cookware, and the locking assembly in an unlocked configuration.

FIG. 21 is a perspective view of the removable handle of FIG. 20, illustrating the locking assembly in a locked configuration.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

For ease of discussion and understanding, the following detailed description will refer to the removable handle in association with “cookware,” while illustrating aspects of the system in association with a pot. It should be appreciated that the pot is provided for purposes of illustration, and the removable handle disclosed herein can be used in association with any suitable cookware, including, but not limited to, kettles, pots, pans, lids, etc. In addition, the removable handle can be used in association with any suitable vessel where it may be desirable to have a selectively removable handle.

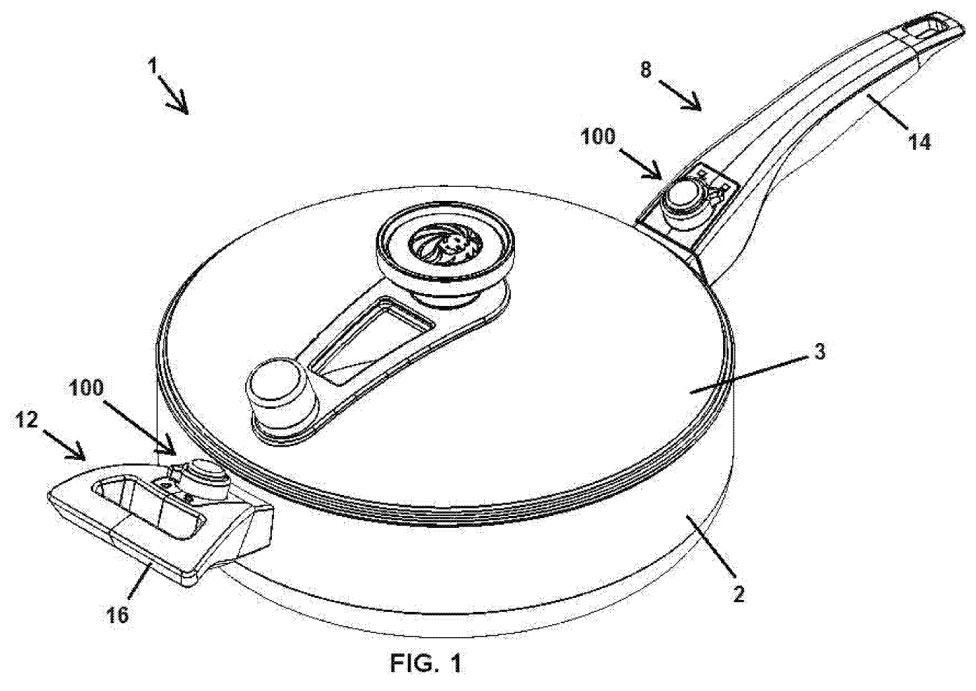

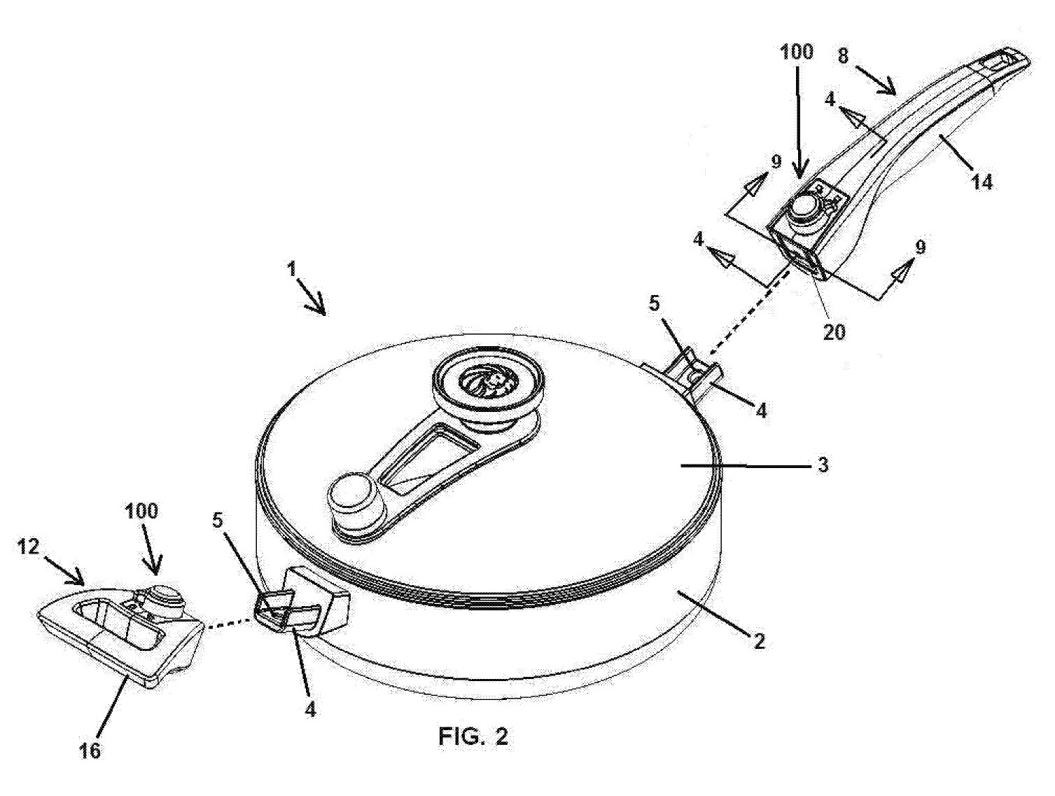

With reference to FIGS. 1-2, an embodiment of a piece of cookware 1, shown as a pot 1, is illustrated. The cookware 1 includes a base 2 that defines a cooking vessel. An optional lid 3 is configured to engage the base 2 and cover the cooking vessel. As shown in FIG. 2, a plurality of mounting members 4 (or mounting portions 4) are coupled to the cookware 1. Each mounting member 4 defines (or includes) an aperture 5 that extends through the mounting member 4. In the illustrated embodiment, the mounting members 4 are coupled to the base 2. However, in other embodiments the mounting members 4 can be positioned on or mounted to any suitable location of the cookware 1. While the illustrated cookware 1 includes a plurality of mounting members 4, in other embodiments, the cookware 1 can include a single mounting member 4, at least one mounting member 4, or any suitable number of mounting members 4.

With reference to FIG. 2, each mounting member 4 is configured to engage a removable handle assembly 8, 12. Each mounting member 4 has a generally U-shaped cross-sectional profile. More specifically, each of the mounting members 4 is in a keyed relationship with a respective removable handle assembly 8, 12 such that each removable handle assembly 8, 12 receives an associated mounting member 4. In other embodiments, the mounting members 4 can have any geometric or other cross-sectional shape suitable to engage a respective removable handle assembly 8, 12.

As illustrated in FIGS. 1-2, a first removable handle assembly 8 includes a first handle 14. The first handle 14 is shown as an elongated handle that, when engaged with the base 2, generally extends radially from the cookware 1. The elongated handle 14 has a shape to allow a user to grasp and move the engaged cookware 1. A second removable handle assembly 12 includes a second handle 16, which is shown as a ring or looped handle. The looped handle 16 is another example of a shape that allows a user to grasp and move the engaged cookware 1. While the illustrated cookware 1 includes one elongated handle 14 and one looped handle 16, in other embodiments the cookware 1 can include any number or shape of handles. For example, the cookware 1 can include one or more looped handles 16, one or more elongated handles 14, a single elongated or looped handle 14, 16, a plurality of different length elongated handles 14, a plurality of different sized looped handles 16, and/or any suitable shaped or sized handle to facilitate user movement of the cookware 1.

As shown in FIGS. 2, 4, 7, 9A, and 9B, each handle assembly 8, 12 includes a channel 20 that is configured to engage a corresponding mounting member 4. The channel 20 is in a keyed relationship with the mounting member 4 (shown in FIG. 2) by having a shape that corresponds to (or is complimentary with) the shape of the mounting member 4. For example, in the illustrated embodiment, the channel 20 has a generally U-shaped cross-sectional profile suitable to receive the U-shaped cross-sectional profile of the mounting member 4. However, in other embodiments, the channel 20 can be any shape, size, or configuration suitable to engage, receive, or otherwise couple to the mounting member 4.

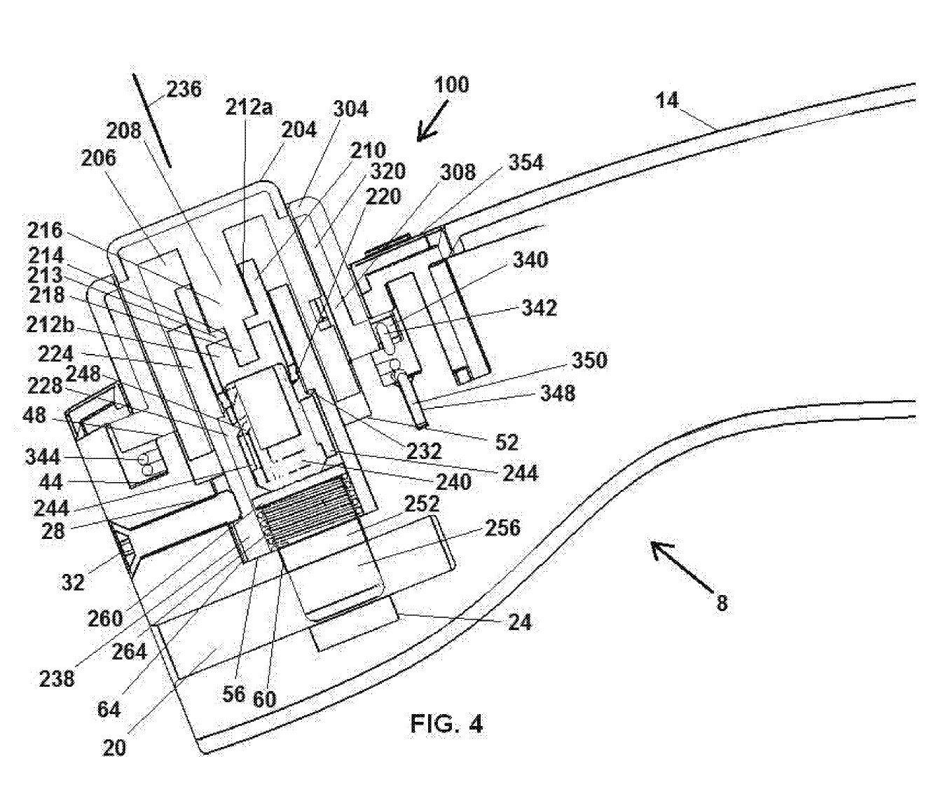

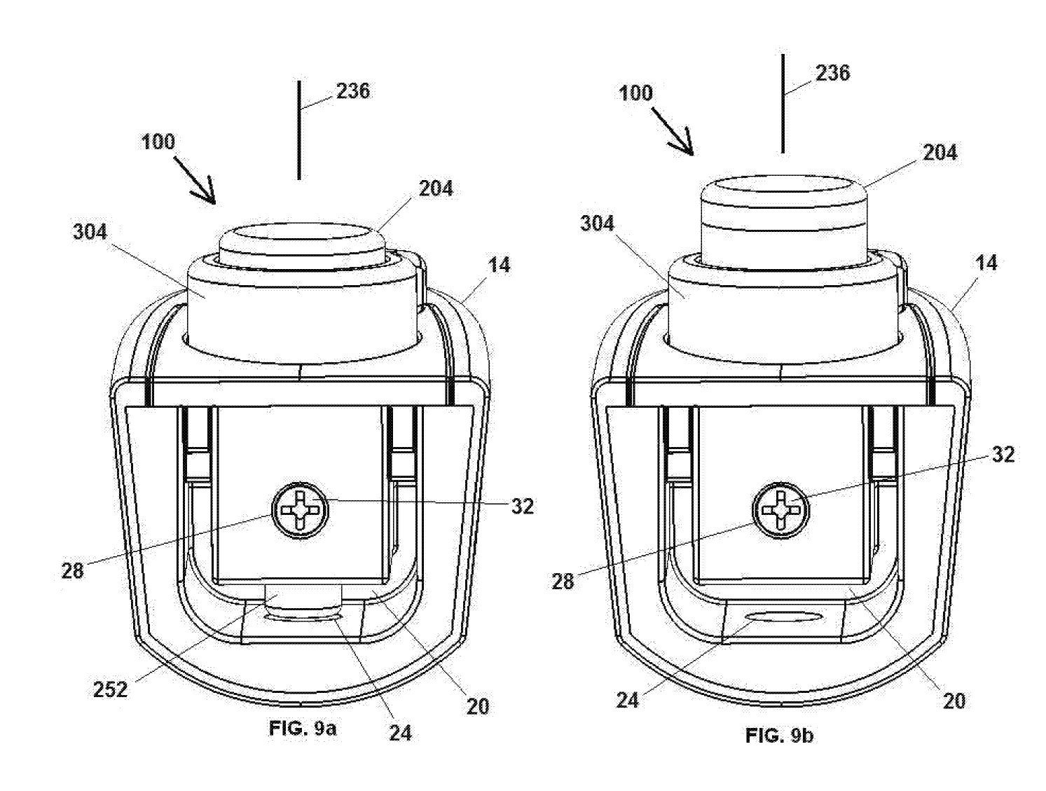

Referring now to FIGS. 4, 9A, and 9B, a depression 24 (or recess 24) can be positioned in the channel 20. The depression 24 is configured to receive a portion of a locking member 252 during operation of a handle locking assembly 100. More specifically, as the handle locking assembly 100 is actuated between an unlocked configuration and a locked configuration (or between a locked configuration and an unlocked configuration), a portion of the locking member 252 slides into the depression 24. Operation of the handle locking assembly 100 is discussed in further detail below.

As shown in FIGS. 4, 7, 9A, and 9B, each handle assembly 8, 12 can include an aperture 28 configured to receive a locking assembly fastener 32. The locking assembly fastener 32, shown as a screw, can be used to assist with fastening (or securing) the handle locking assembly 100 that is positioned in a handle locking assembly receiving aperture 40 in the respective handle assembly 8, 12. For example, as shown in FIG. 4, the locking assembly fastener 32 can engage with a portion of the locking assembly 100 to assist with retention of the handle locking assembly 100 in the illustrated first handle assembly 8. In other embodiments, the locking assembly 100 can be retained in or coupled to a portion of each handle assembly 8, 12 by any suitable fastener or retention assembly.

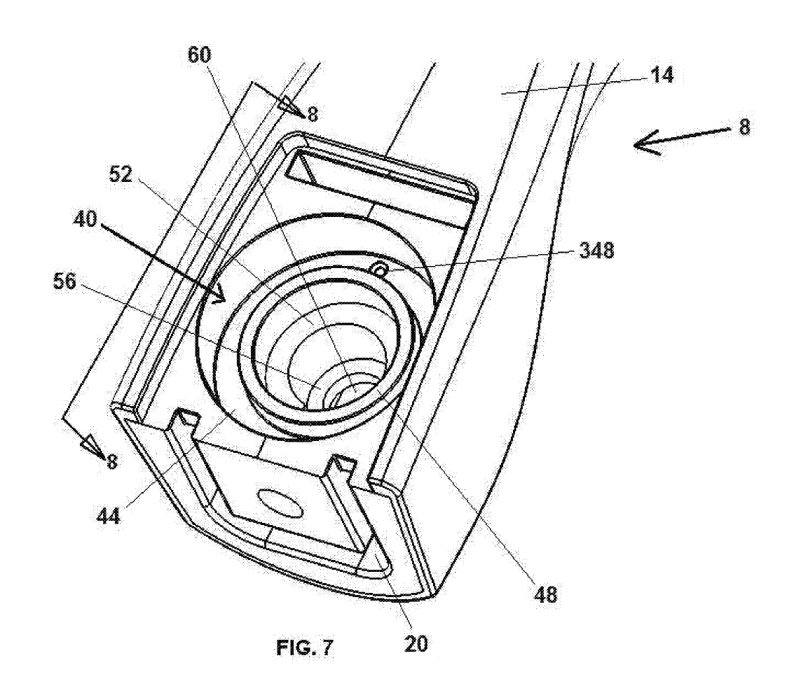

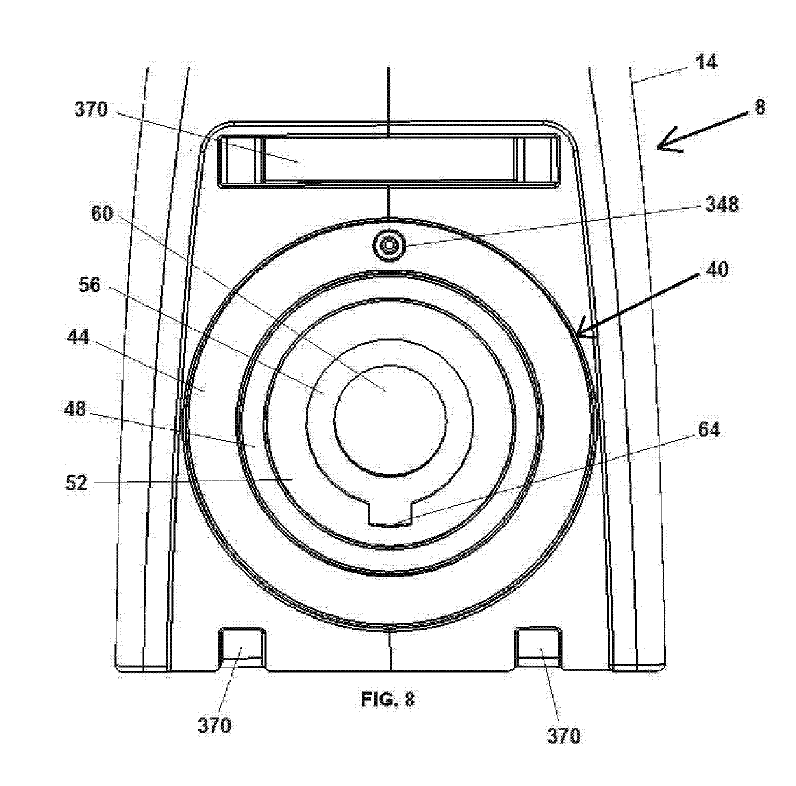

As shown in FIGS. 7-8, the handle locking assembly receiving aperture 40 can include a plurality of concentric surfaces configured to contact different components of the handle locking assembly 100. The surfaces can include a first surface 44, a second surface 48, a third surface 52, and a fourth surface 56 that are concentrically positioned around a central aperture 60. In the illustrated embodiment, the first surface 44 can have a diameter greater than the second, third, and fourth surfaces 48, 52, 56, the second surface 48 can have a diameter greater than the third and fourth surfaces 52, 56, and the third surface can have a diameter greater than the fourth surface 56. In addition, the surfaces 44, 48, 52, 56 can be positioned at different heights or levels along the central aperture 60. For example, the second surface 48 can be positioned at a first height above the first, third, and fourth surfaces 44, 52, 56. Further, the first surface 44 can be positioned above the third and fourth surfaces 52, 56, while the third surface 52 can be positioned above the fourth surface 56. The fourth surface 56 can also define a key slot 64.

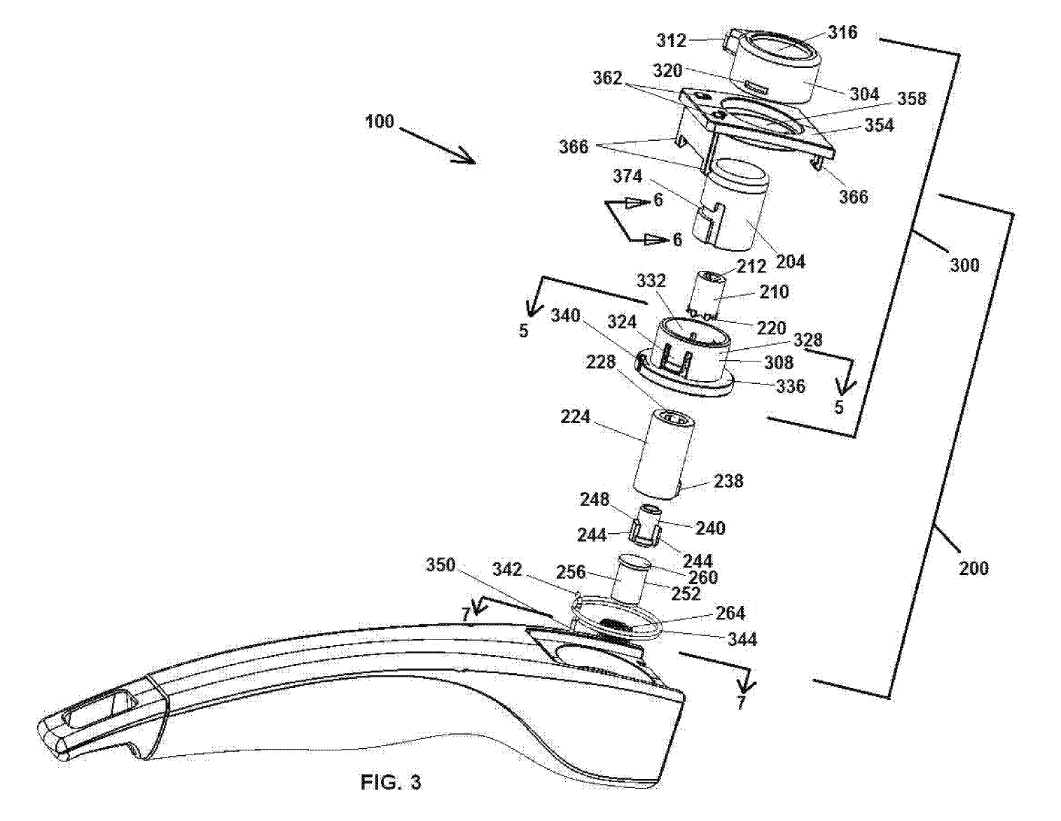

Referring now to FIGS. 3-4, an embodiment of the handle locking assembly 100 is illustrated. The handle locking assembly 100 selectively locks each associated handle assembly 8, 12 to the cookware 1. The locking assembly 100 is provided to assist with preventing unintentional detachment of the handle assembly 8, 12 from the cookware 1. While the handle assemblies 8, 12 are illustrated with different handles 14, 16 in FIGS. 1-2, the locking assembly 100 included in each handle assembly 8, 12 is the same. For simplicity, the handle locking assembly 100 is illustrated in association with the first handle assembly 8 and the first handle 14. However, it should be appreciated that the same handle locking assembly 100 can be used in association with the second handle assembly 12 and the second handle 16.

Referring now to FIG. 3, the handle locking assembly 100 is a multicomponent locking assembly that includes a first locking subassembly 200 (or first locking assembly 200) and a second locking subassembly 300 (or second locking assembly 300). In the illustrated embodiment, the second locking subassembly 300 receives a portion of the first locking subassembly 200. The first locking subassembly 200 is configured to lock the handle 14 to the cookware 1, while the second locking subassembly 300 is configured to lock the first locking subassembly 200 to limit unintended or accidental unlocking of the first locking subassembly 200 from the cookware 1.

As illustrated in FIGS. 3-4, the first locking subassembly 200 includes a depressible push button 204. The push button 204 includes a hollow interior passage 206 (shown in FIG. 4) and a projection 208 (shown in FIG. 4) that is positioned in the passage 206. The push button 204 receives a plunger 210 that defines an internal passage 212. As shown in FIG. 4, the plunger 210 is in a keyed relationship with the push button 204, such that the projection 208 is received by the passage 212 of the plunger 210, and more specifically a first end of the passage 212a. A second end of the passage 212b is separated from the first end 212a by a narrowing projection 213 (or portion 213). The narrowing projection 213 defines an aperture 214 that has a diameter that is generally smaller than an inside diameter of the passage 212. In the illustrated embodiment, the projection 208 includes a first portion 216 and a narrower second portion 218. The first portion 216 is sized to be received by the first end 212a of the passage 212, while the narrower, second portion 218 is sized to be received by the aperture 214. Stated another way, the first portion 216, which has a larger diameter than the second portion 218, is too large to fit in the aperture 214 and instead engages the narrowing projection 213. A plurality of teeth 220 are positioned on an outer surface of the plunger 210. The teeth 220 radially extend away from the plunger 210.

Referring back to FIGS. 3-4, the plunger 210 is received by a substantially hollow stop member 224. The stop member 224 is also received by the push button 204. The stop member 224 defines an internal passage 228 that includes a plurality of spaced apart longitudinal ribs 232 (shown in FIG. 4). With continued reference to FIG. 4, the ribs 232 decrease an inside diameter of the internal passage 228. In addition, the ribs 232 can be arranged approximately parallel to an axis 236 that defines the direction that the push button 204 depresses or translates. A stop member protrusion 238 is positioned on an outer surface of the stop member 224. The stop member protrusion 238 extends away from the stop member 224, and is configured to be received by (or align with) key slot 64. As shown in FIG. 4, with the stop member protrusion 238 positioned in the key slot 64, the locking assembly fastener 32 can engage with the stop member protrusion 238 to assist with retention of the handle locking assembly 100, and more specifically the first locking subassembly 200.

As shown in FIGS. 3-4, a follower 240 includes a plurality of spaced apart, elongated projections 244 radially positioned on an outer surface. Each projection 244 includes a sloped end 248. Each projection 244 also extends along the follower 240 approximately parallel to the axis 236. The follower 240 is received by the stop member 224 in the internal passage 228. In addition, the follower 240 is received by the plunger 210 in the second end 212b of the passage 212. In the received arrangement of the first locking subassembly 200, the push button 204, stop member 224, plunger 210, and follower 240 are concentric (as shown in FIG. 4).

The follower 240 is in contact with, or otherwise operably connected to, the locking member 252. The locking member 252 includes a body 256 and a head portion 260, with the head portion 260 having a diameter that is greater than the body 256. The locking member 252 is received by the stop member 224 in the internal passage 228. A biasing member 264 (or first spring 264) receives the locking member 252 and surrounds the body 256. The biasing member 264 applies a bias to the locking member 252 by the head portion 260 in a direction towards the push button 204.

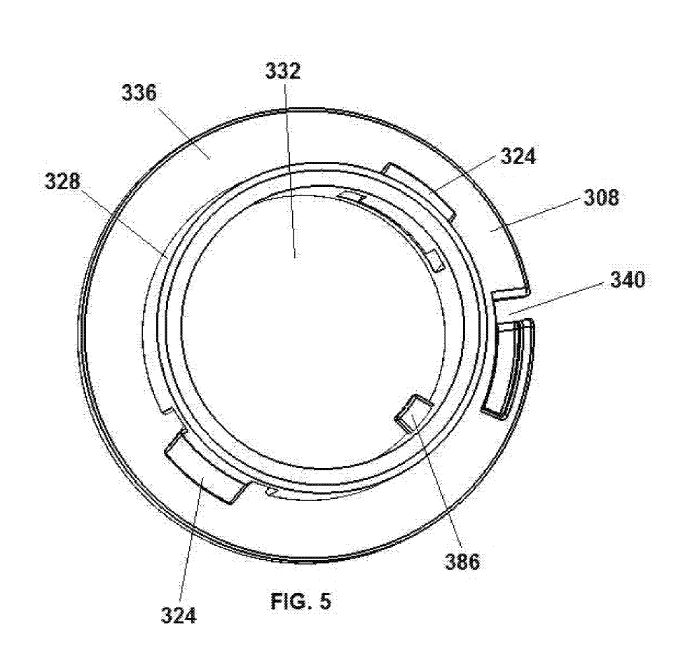

As best illustrated in FIG. 3, the second locking subassembly 300 includes a first locking collar 304 coupled to a second locking collar 308. The first locking collar 304 has a protrusion or knob 312 positioned on an outer surface. In the illustrated embodiment, the knob 312 extends radially from the outer surface of the first locking collar 304. A central aperture 316 extends through the first locking collar 304. In addition, at least one, and preferably a plurality of locking slots 320 can be positioned through the first locking collar 304. The locking slots 320 can be positioned through the outer surface of the first locking collar 304. The locking slots 320 can further be configured to engage a respective clip member 324 positioned on the second locking collar 308 to couple the first and second locking collars 304, 308. As illustrated in FIG. 5, each clip member 324 is biased into engagement with a corresponding locking slot 320 (e.g. outward from the second locking collar 308, etc.), and further is configured to be received by a respective locking slot 320. In the illustrated embodiment, the first locking collar 304 includes a pair of locking slots 320, while the second locking collar 308 includes a pair of corresponding clip members 324. In other embodiments, the locking collars 304, 308 can include any suitable combination of locking slots 320 and clip members 324 (e.g., one of each, a plurality of each, etc.). In addition, in other embodiments, the first locking collar 304 can include the clip member(s) 324, while the second locking collar 308 can include the locking slot(s) 320.

As shown in FIGS. 3 and 5, the second locking collar 308 can include a housing 328 that is substantially hollow and defines a central aperture 332. A rim 336 (or a ridge or portion 336) can be positioned on the housing 328 that has a diameter that is greater than the diameter of housing 328. A slot 340 can be positioned on (or through) the rim 336. The slot 340 can be configured to receive (or engage) a first end 342 of a biasing member 344 (shown in FIGS. 3-4). The biasing member 344 is illustrated as a torsion spring, however any member suitable to bias the second locking collar 308 and/or the second locking subassembly 300 can be used. A second slot 348 (shown in FIGS. 4 and 7) in the handle 14 can be configured to receive (or engage) a second end 350 of the biasing member 344.

Referring back to FIG. 3, a cover 354 can be positioned between the first and second locking collars 304, 308. The collar 354 includes a central aperture 358 that has a diameter that is less than the diameter of the rim 336. This allows cover 354 to be positioned and retained between the engaged first and second locking collars 304, 308 in a “sandwich” type arrangement. The cover 354 can include indicia 362 indicating when the second locking subassembly 300 is in a locked configuration or an unlocked configuration. The cover 354 can further include a plurality of hooked cover legs 366. The cover legs 366 can be configured to engage corresponding receptacles 370 (shown in FIG. 8) in the handle 14, coupling or otherwise engaging the cover 354 to the handle 14.

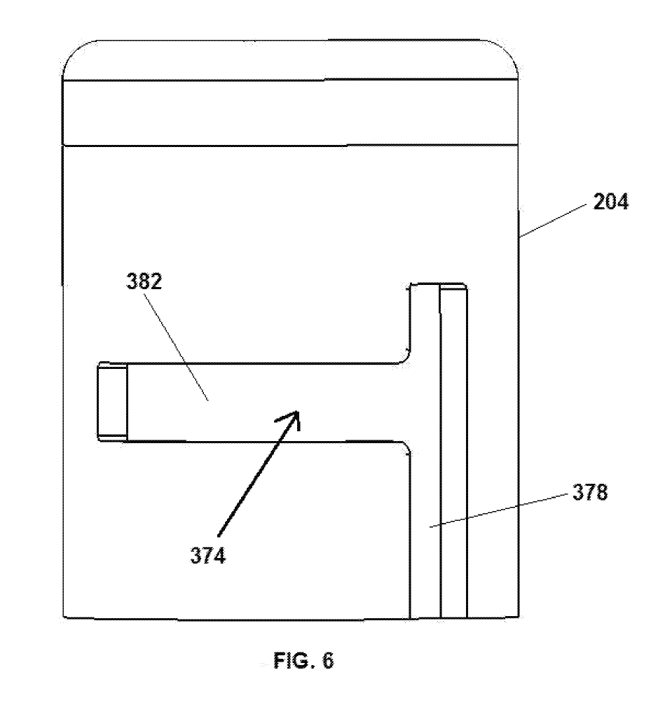

With reference to FIGS. 3 and 6, the push button 204 can include a channel system 374 positioned on an exterior (or outside) surface. With specific reference to FIG. 6, the channel system 374 can include a first channel 378 and a second channel 382. The first channel 378 can be positioned in a direction of travel of the push button 204 (e.g., approximately parallel to the axis 236, shown in FIG. 4). The second channel 382 can be approximately perpendicular to the first channel 378. It should be appreciated that in other embodiments, the channel system 374 can includes a plurality of offset second channels 382 that are in communication with the first channel 378. The channel system 374 is configured to slidably receive a projection 386 (shown in FIG. 5) on the second locking collar 308. With specific reference to FIG. 5, the projection 386 can extend from the housing 328 into the central aperture 332.

The locking assembly 100 is positioned in the handle locking assembly receiving aperture 40. With specific reference to FIG. 4, the locking member 252 extends through the central aperture 60 and into the channel 20. Further, the locking member 252 is configured to slide or translate in the aperture 60 along the axis 236. The stop member 224 is positioned to contact the fourth surface 56, and preferably does not slide or otherwise move during operation of the locking assembly 100. The push button 204 is configured to slide or translate in the aperture 40 along the axis 236 until contacting the third surface 52. The second locking collar 308 is positioned to contact the second surface 48, while the biasing member 344 is positioned to contact the first surface 44.

FIGS. 9A-9B respectively illustrate the locking assembly 100 in a locked configuration and an unlocked configuration. In the locked configuration shown in FIG. 9A, the push button 204 has been depressed along the axis 236 to overcome the bias from biasing member 238. By depressing the push button 204, the push button 204 slides (or translates) within the first locking collar 304 (and second locking collar 308, shown in FIG. 4) towards the handle 14. As the push button 204 slides, the biasing member 238 is held in a compressed position, and the locking member 252 slides within the aperture 60 towards the handle 14, sliding into the channel 20. In the unlocked configuration shown in FIG. 9B, the push button 204 has again been depressed along the axis 236. By depressing the push button 204, the biasing member 238 is released from the compressed position. The locking member 252 also slides into the depression 24 before retracting out of the channel 20 and into the locking assembly 100. More specifically, the biasing member 238 directs the locking member 252 to slide (or translate) within the aperture 60 towards the push button 204, withdrawing the locking member 252 completely from the channel 20.

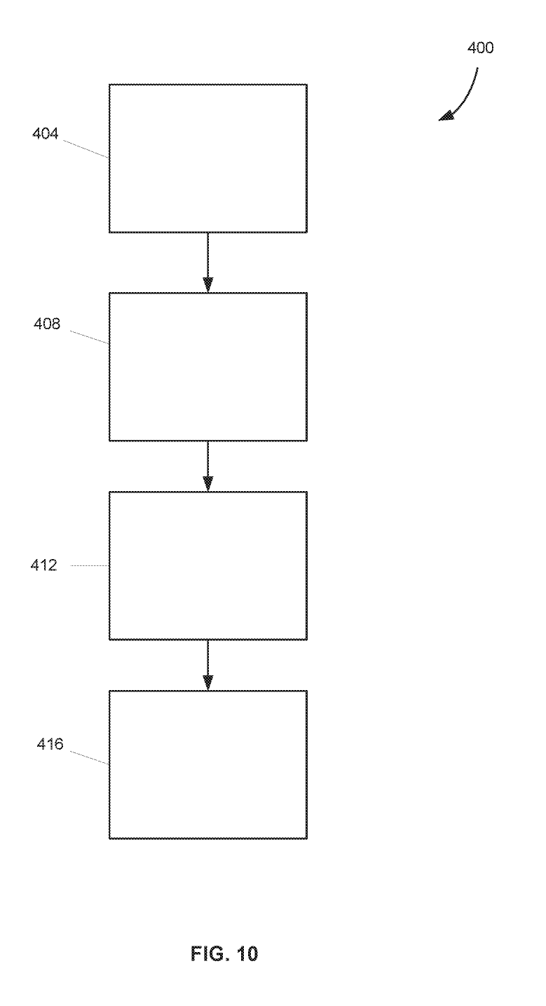

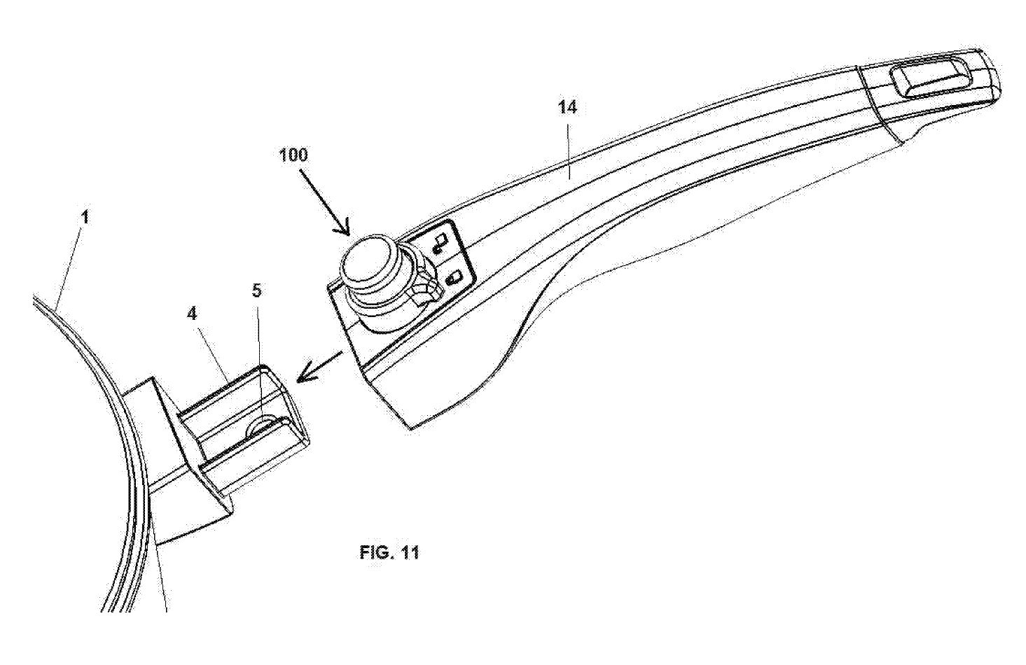

FIG. 10 illustrates a method 400 of engaging a removable handle 14 (and/or handle 18) with cookware 1, and further operating the locking assembly 100 to selectively lock the handle 14 (and/or handle 18) to the cookware 1. Several steps of the method depicted in FIG. 10 have a corresponding structural arrangement that is respectively illustrated in FIGS. 11-15.

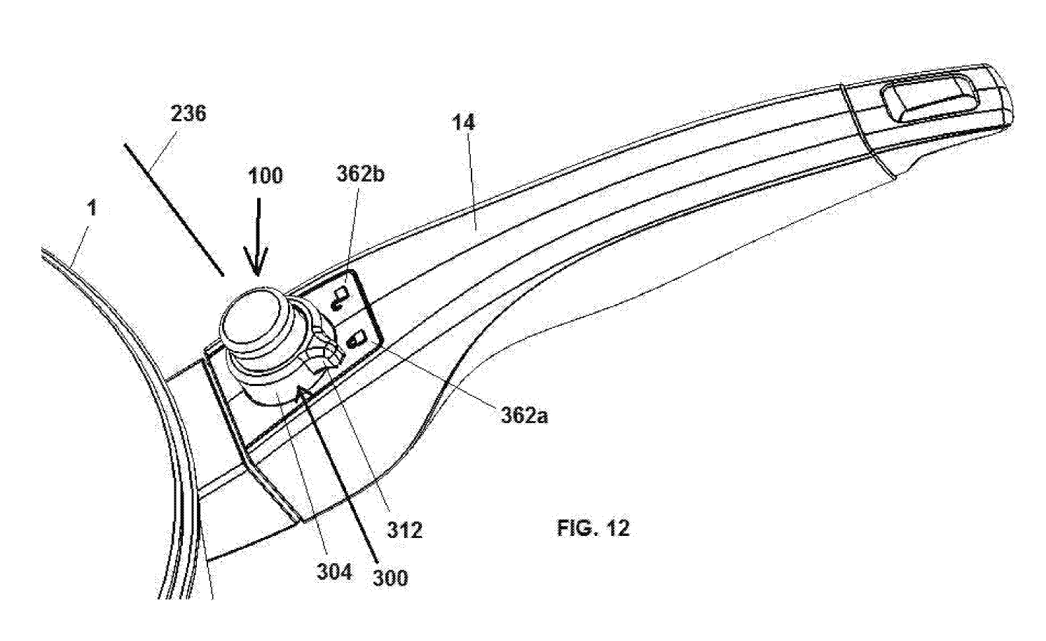

Referring to FIG. 10, the method 400 begins at step 404, where the handle 14 is placed into engagement with the cookware 1. As illustrated in FIG. 11, the handle 14 is moved into engagement with the cookware 1, with the channel 20 (shown in FIG. 7) in the handle 14 receiving one of the mounting members 4. Once the handle 14 receives the mounting member 4, the handle 14 is in engagement with the cookware 1, as shown in FIG. 12.

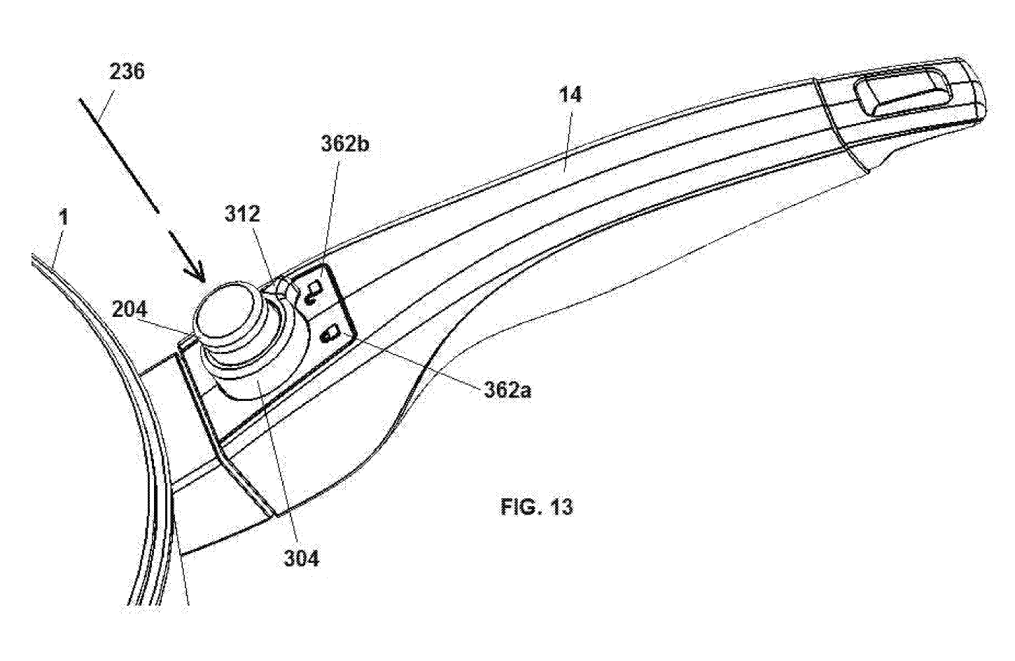

Next, with the handle 14 in engagement with the cookware 1, a user actuates the handle locking assembly 100 to lock the handle 14 to the cookware 1. At step 408 the user initiates locking by rotating the first locking collar 304 of the second locking subassembly 300 about the axis 236. For example, the user can apply a force to the knob 312 sufficient to rotate the knob from a first indicia 362a (shown in FIG. 12), that indicates the second locking subassembly 300 is locked, to a second indicia 362b (shown in FIG. 13), that indicates the second locking subassembly 300 is unlocked. During rotation of the second locking subassembly 300, the first locking collar 304 and the second locking collar 308 rotate together. The force applied by the user is sufficient to overcome a biasing force applied on the second locking subassembly 300 by the biasing member 344 (shown in FIG. 4). The biasing force applied by the biasing member 344 applies sufficient rotational force on the second locking subassembly to position the projection 386 (shown in FIG. 5) in the second channel 382 (on the push button 204, shown in FIG. 6) at an end opposite the first channel 378 (also shown in FIG. 6). Overcoming the biasing force and rotating the locking collars 304, 308 slides the projection 386 along the second channel 382 into alignment with the first channel 378. Once the projection 386 is in alignment with the first channel 378 (e.g., the first locking collar 304 is rotated to the second indicia 362b, as shown in FIG. 13), the user can actuate the first locking subassembly 200 to deploy the locking member 252 into engagement with the mounting member 4 at step 412.

During step 412, the user continues to maintain sufficient force on the first locking collar 304 to continue to overcome the biasing force applied by the biasing member 344. The user then actuates the first locking subassembly 200 by depressing the push button 204 in a direction along the axis 236. The user applies a force to the push button 204 sufficient to overcome a biasing force applied to the push button 204 by the biasing member 264 (shown in FIG. 4). More specifically, as the user depresses the push button 204, the projection 386 slides along the first channel 378, allowing the push button 204 to slide (or translate) within the second locking subassembly 300 (e.g., the first and second locking collars 304, 308). The push button 204 also displaces the plunger 210, sliding the plunger 210 within the stop member 224. With reference to FIGS. 3-4, as the plunger 210 slides, each of the radial teeth 220 engage a corresponding sloped end 248 of each projection 244 on the follower 240. More specifically, as the plunger 210 slides within the stop member 224 along the axis 236, the plunger 210 moves the follower 240, such that the follower 240 also slides within the stop member 224 along the axis 236. As the plunger 210 and the follower 240 slide along the axis 236, the follower 240 contacts the locking member 252, and more specifically the head portion 260 of the locking member 252. The follower 240 thus slides (or translates) the locking member 252, compressing the biasing member 264. The locking member 252 is pushed (by the plunger 210 and the follower 240) through the aperture 60 and into the channel 20, where it is received by the aperture 5 that extends through the mounting member 4 (shown in FIG. 11).

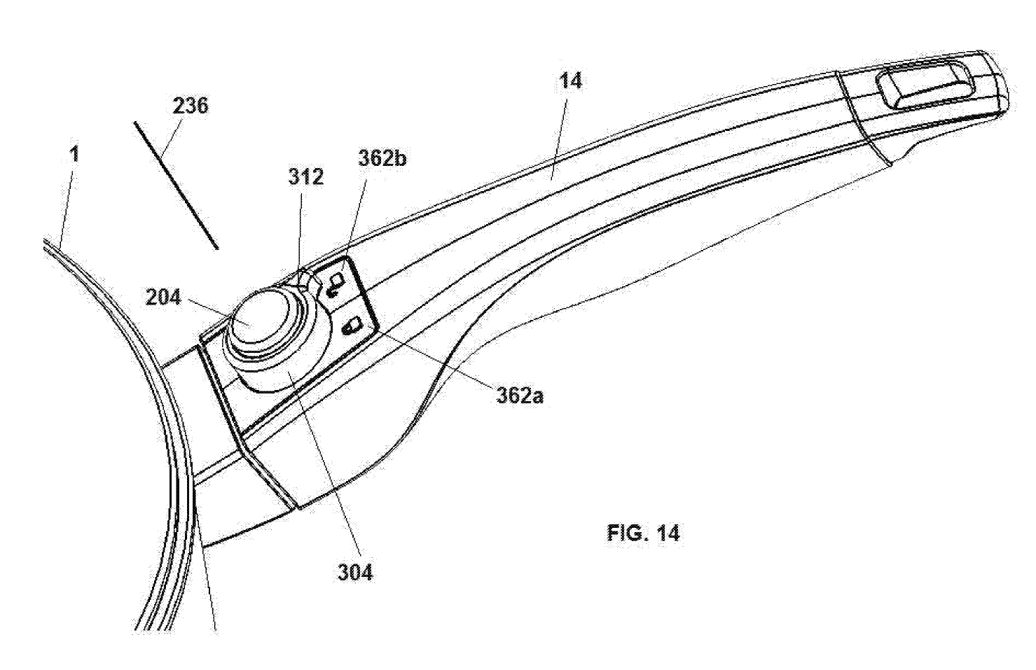

As illustrated in FIG. 14, once the push button 204 is fully depressed (and the corresponding plunger 210 and follower 240 slide within the stop member 224, sliding the locking member 252 into engagement with the aperture 5 of the mounting member 4), the locking member 252 is received by the aperture 5 of the mounting member 4. The user then removes further downward force on the push button 204, allowing the biasing member 264 to apply a biasing force on the push button 204. More specifically, the biasing member 264 applies a biasing force to the locking member 252. The biased locking member 252 slides into the follower 240, which is in turn in contact with the plunger 210, and the plunger 210 is in contact with the push button 204. As the biasing member 264 applies the biasing force on the locking member 252, the follower 240 and the plunger 210 slide along the axis 236 towards the push button 204. During this sliding (or translational) movement, the follower 240 also rotates about the axis 236. The rotation is generated by the plunger 210, and more specifically by each radial tooth 220 sliding along the respective sloped end 248 of the projection 244. As the follower 240 rotates, the projections 244 on the follower 240 come into contact with the ribs 232 inside the stop member 224. Once in contact, the ribs 232 restrict further sliding movement of the follower 240, maintaining the follower 240 in a partially extended (or not fully retracted position). Thus, the follower 240 maintains the position of the locking member 252 in the aperture 5 of the mounting member 4. However, the biasing member 264 applies sufficient biasing force to move the push button 204, such that the projection 386 slides along the first channel 378 and into alignment with the second channel 382 (or one of a plurality of second channels 382).

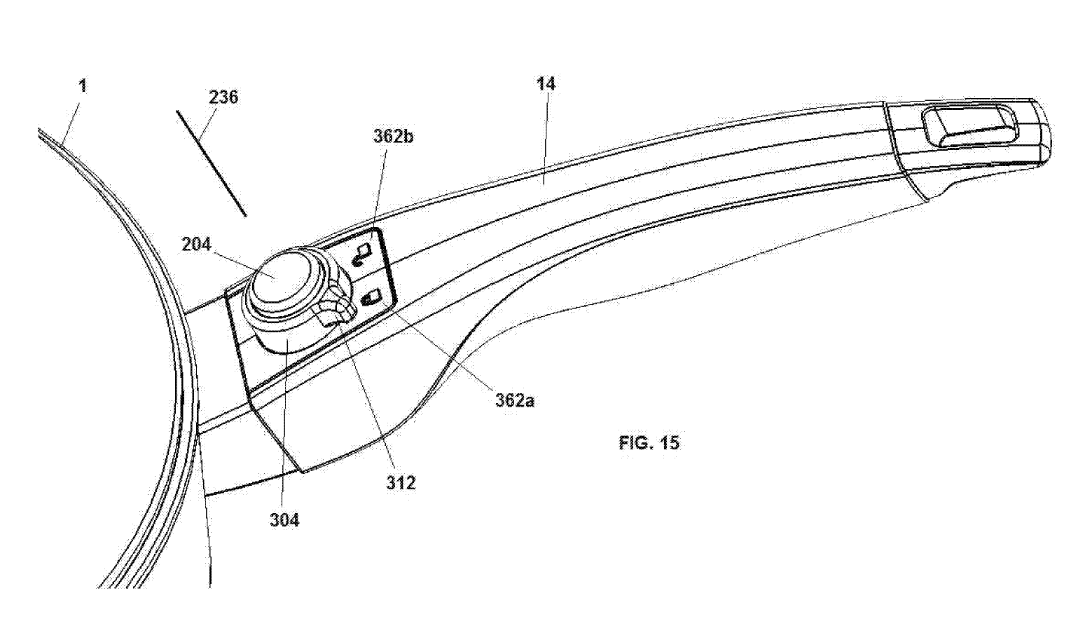

Next at step 416, the user releases the force applied on the first locking collar 304, allowing the biasing force applied by the biasing member 344 to rotate the first and second locking collar 304, 308 about the axis 236. As the first and second locking collars 304, 308 rotate, the projection 386 slides from the first channel 378 along the second channel 382. Once the projection 386 is received by the second channel 382, the push button 204 is restricted from sliding movement along the axis 236. Stated another way, the push button 204 and the associated first locking subassembly 200 is restricted (or locked) from actuation. Thus, the second locking subassembly 300 restricts further actuation of the first locking subassembly 200, and the locking member 252 remains engaged with the mounting member 4 (e.g., received by the aperture 5). FIG. 15 illustrates the second locking subassembly 300 in a locked configuration (e.g., the first locking collar 304 and the second locking collar 308 rotated about the axis 236, and the knob 312 rotated from the second indicia 362b (shown in FIG. 14) to the first indicia 362a (shown in FIG. 15) indicating the locked configuration).

To disengage the locking member 252 from the mounting member 4 (e.g., to remove the locking member 252 from the aperture 5), the user repeats the steps of method 400. However, during step 412, when the user fully depresses the push button 204, the locking member 252 can extend into the recess 24 provided proximate the channel 20, as shown in FIGS. 9A-9B. This accounts for additional lateral or sliding travel of the locking member 252 in certain embodiments of the locking assembly 100. In addition, in response to the user removing further downward force on the push button 204, the biasing member 264 applies the biasing force on the locking member 252, the follower 240, the plunger 210, and the push button 204, sliding these elements away from the channel 20. As the follower 240 slides, it rotates out of engagement with the ribs 232, allowing the follower 240 to slide further towards the push button 204 (or further away from the channel 20). This additional sliding movement of the follower 240 allows for the locking member 252 to be fully withdrawn (or retracted) from the aperture 5 of the mounting member 4, and further withdrawn (or retracted) from the channel 20. This in turn frees the handle 14 to be removed from the cookware 1, as the locking member 252 no longer obstructs removal of the mounting member 4 from the channel 20 in the handle 14.

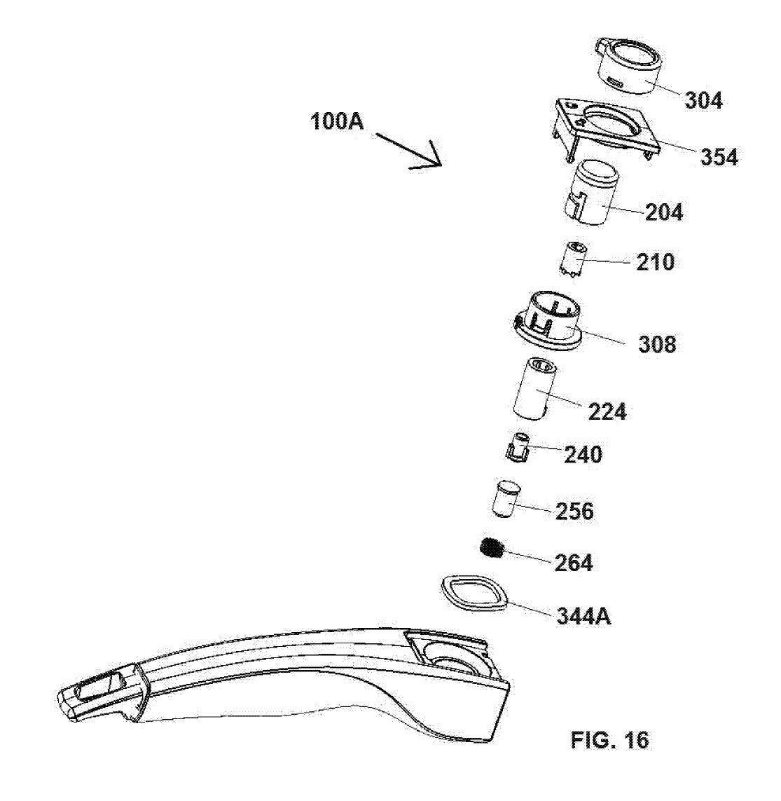

FIG. 16 illustrates an example of another embodiment of a handle locking assembly 100A. For ease of understanding, like numbers will be used to identify like components. With reference to FIG. 16, in this embodiment, the handle locking assembly 100A is substantially the same as handle locking assembly 100, except for the biasing member 344. In this embodiment, the biasing member 344A is a wave disc spring 344A (in place of a torsion spring 344). The biasing member 344A is positioned to contact the first surface 44 (see FIG. 4), and apply a biasing force to the second locking subassembly 300. However, unlike the biasing member 344, the biasing member 344A applies a constant biasing force against the second locking subassembly 300 in a direction towards the axis 236. Stated another way, rather than bias the second locking subassembly 300 rotationally towards the locked configuration (like the biasing member 344), the biasing member 344A biases the second locking subassembly 300 such that when rotated to the unlocked configuration (from the position in FIG. 12 to the position in FIG. 13), the second locking subassembly 300 will remain in the unlocked configuration (shown in FIG. 13) when the user removes the rotational force on the second locking subassembly 300. This is due to the biasing member 344A applying the biasing force on the second locking subassembly 300 in the direction towards the axis 236, maintaining the position of the second locking subassembly 300. Similarly, when the user rotates the second locking subassembly 300 from the unlocked configuration to the locked configuration (from the position in FIG. 13 to the position in FIG. 12), the second locking subassembly 300 will remain in the locked configuration (shown in FIG. 12) when the user removes the rotational force on the second locking subassembly 300 (again, due to the biasing member 344A applying the biasing force on the second locking subassembly 300 in the direction towards the axis 236). Accordingly, in operation of the handle locking assembly 100A, the user does not have to maintain the force on the knob 312 after rotating the knob 312 from the first indicia 362a (shown in FIG. 12) to the second indicia 362b, as the biasing member 344A is applying a bias in a direction of axis 236, rather than a rotational force about the axis 236.

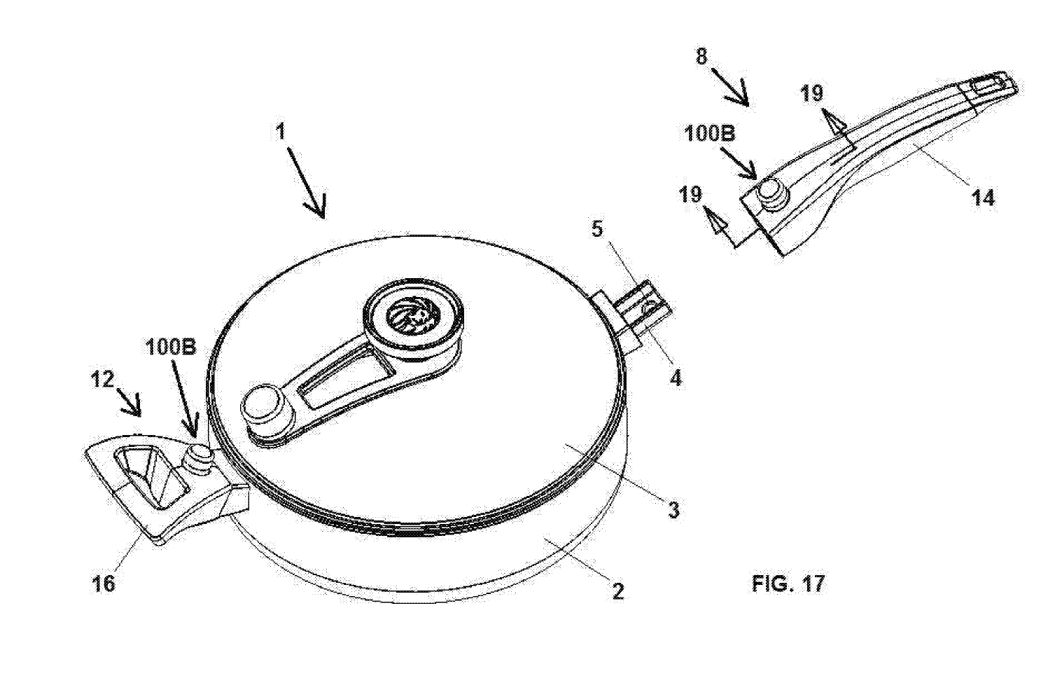

FIGS. 17-21 illustrate an example of another embodiment of a handle locking assembly 100B. For ease of understanding, like numbers will be used to identify like components. With reference to FIG. 17, in this embodiment, the cookware 1 includes removable handle assemblies 8, 12, with each removable handle assembly 8, 12 having a respective handle 14, 16. The handles 14, 16 can each include the handle locking assembly 100B. The handle locking assembly 100B selectively locks each associated handle assembly 8, 12 to the cookware 1. While the handle assemblies 8, 12 are illustrated with different handles 14, 16 in FIG. 17, the handle locking assembly 100B included in each handle assembly 8, 12 is the same. For simplicity, the handle locking assembly 100B is illustrated in association with the first handle assembly 8 and the first handle 14. However, it should be appreciated that the same handle locking assembly 100B can be used in association with the second handle assembly 12 and the second handle 16.

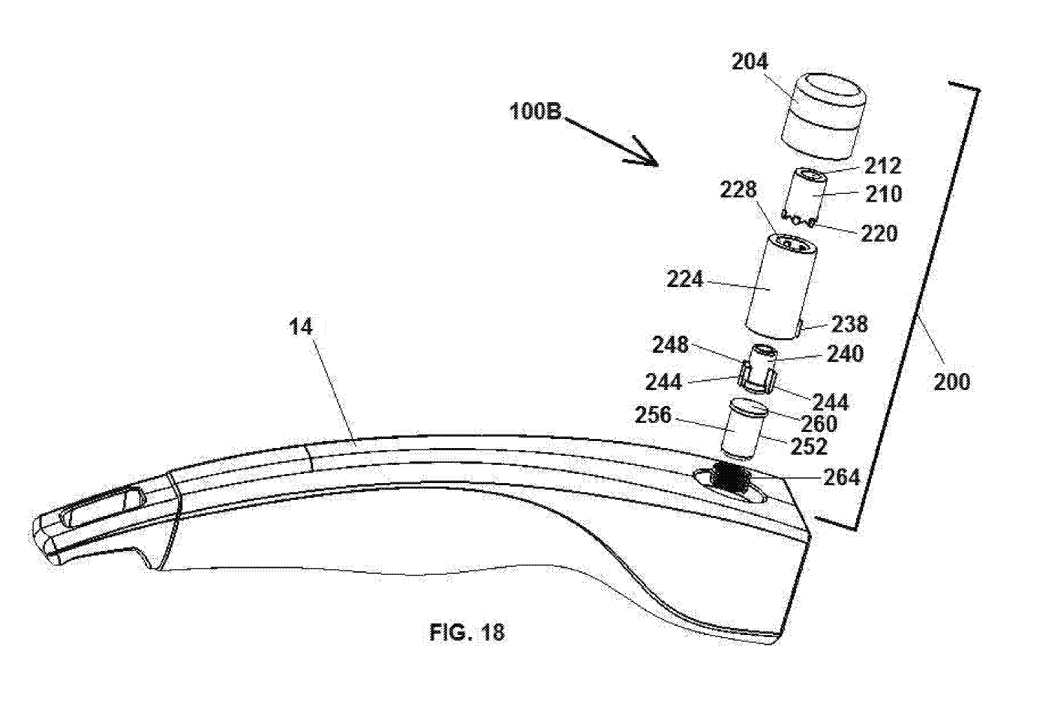

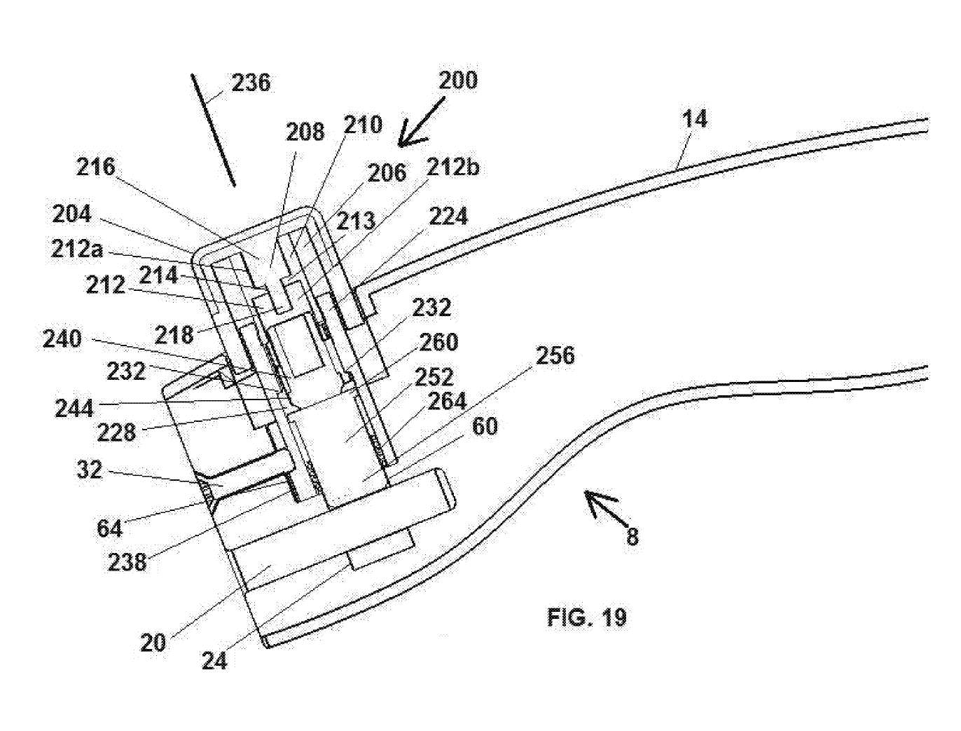

With reference to FIGS. 18-19, this embodiment of the handle locking assembly 100B includes the first locking subassembly 200 (or first locking assembly 200). The first locking subassembly 200 is configured to lock the handle 14 to the cookware 1. The first locking subassembly 200 includes the depressible push button 204 having the hollow interior passage 206 (shown in FIG. 19) and the projection 208 (shown in FIG. 19) that is positioned in the passage 206. The push button 204 receives the plunger 210, which defines the internal passage 212. As shown in FIG. 19, the plunger 210 is in a keyed relationship with the push button 204, such that the projection 208 is received by the passage 212 of the plunger 210, and more specifically the first end of the passage 212a. The second end of the passage 212b is separated from the first end 212a by the narrowing projection 213 (or portion 213). The narrowing projection 213 defines the aperture 214 that has a diameter that is generally smaller than the inside diameter of the passage 212. In the illustrated embodiment, the projection 208 includes the first portion 216 and the narrower second portion 218. The first portion 216 is sized to be received by the first end 212a of the passage 212, while the narrower, second portion 218 is sized to be received by the aperture 214. Stated another way, the first portion 216, which has a larger diameter than the second portion 218, is too large to fit in the aperture 214 and instead engages the narrowing projection 213. The plurality of teeth 220 are positioned on an outer surface of the plunger 210. The teeth 220 radially extend away from the plunger 210.

With reference back to FIGS. 18-19, the plunger 210 is received by the substantially hollow stop member 224. The stop member 224 is also received by the push button 204. The stop member 224 defines the internal passage 228 that includes the plurality of spaced apart longitudinal ribs 232 (shown in FIG. 19). With continued reference to FIG. 19, the ribs 232 decrease the inside diameter of the internal passage 228. In addition, the ribs 232 can be arranged approximately parallel to the axis 236 that defines the direction that the push button 204 depresses or translates. The stop member protrusion 238 is positioned on the outer surface of the stop member 224. The stop member protrusion 238 extends away from the stop member 224, and is configured to be received by (or align with) the key slot 64. With the stop member protrusion 238 positioned in the key slot 64, the locking assembly fastener 32 can engage with the stop member protrusion 238 to assist with retention of the handle locking assembly 100B, and more specifically the first locking subassembly 200.

Referring back to FIGS. 18-19, the follower 240 includes the plurality of spaced apart, elongated projections 244 radially positioned on the outer surface. Each projection 244 includes the sloped end 248 (shown in FIG. 18). Each projection 244 also extends along the follower 240 approximately parallel to the axis 236. The follower 240 is received by the stop member 224 in the internal passage 228. In addition, the follower 240 is received by the plunger 210 in the second end 212b of the passage 212. In this received arrangement of the first locking subassembly 200, the push button 204, stop member 224, plunger 210, and follower 240 are concentric (as shown in FIG. 19).

The follower 240 is in contact with, or otherwise operably connected to, the locking member 252. The locking member 252 includes the body 256 and the head portion 260, with the head portion 260 having a diameter that is greater than the body 256. The locking member 252 is received by the stop member 224 in the internal passage 228. The biasing member 264 (or first spring 264) receives the locking member 252 and surrounds the body 256. The biasing member 264 applies a bias to the locking member 252 by the head portion 260 in a direction towards the push button 204.

To operate the handle locking assembly 100B, and more specifically lock the handle 14 to the cookware 1, the user performs a portion of the steps of method 400, and more specifically steps 404 and 412.

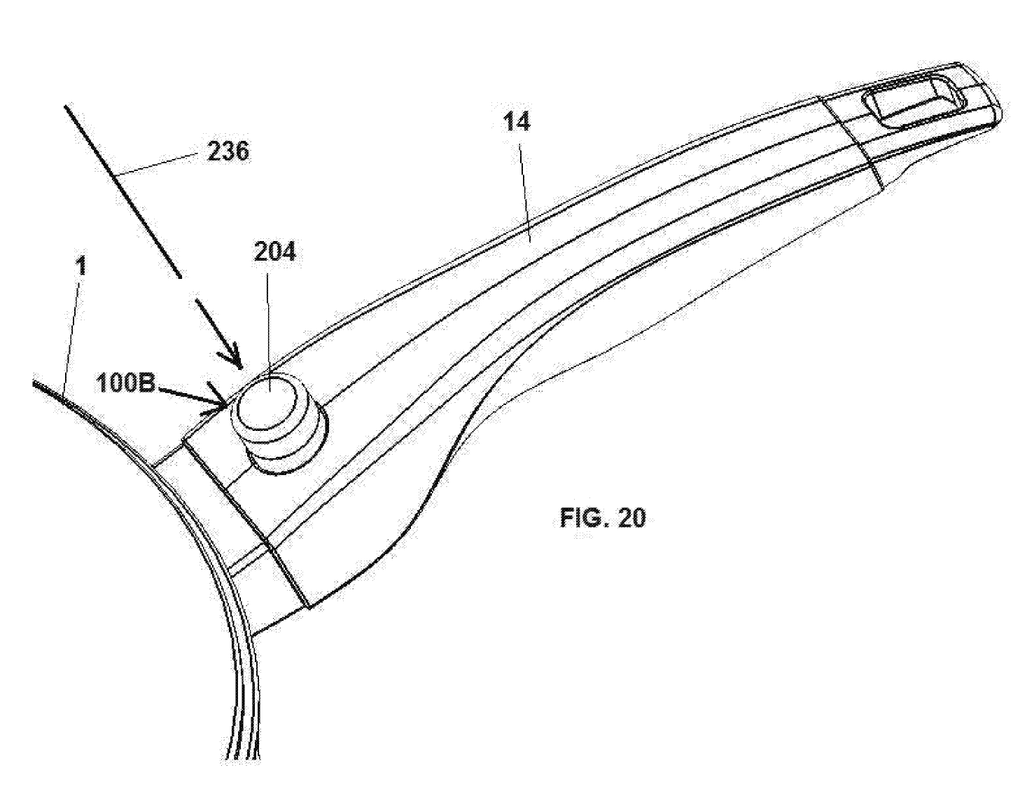

At step 404, the handle 14 is placed into engagement with the cookware 1, and more specifically the handle 14 is moved into engagement with the cookware 1, with the channel 20 in the handle 14 receiving one of the mounting members 4. Once the handle 14 receives the mounting member 4, the handle 14 is in engagement with the cookware 1, as shown in FIG. 20.

Next, at step 412, the user actuates the first locking subassembly 200 by depressing the push button 204 in a direction along the axis 236. The user applies a force to the push button 204 sufficient to overcome the biasing force applied to the push button 204 by the -biasing member 264 (shown in FIGS. 18-19). As the user depresses the push button 204, the push button 204 displaces the plunger 210, sliding the plunger 210 within the stop member 224. As the plunger 210 slides, each of the radial teeth 220 engage a corresponding sloped end 248 of each projection 244 on the follower 240. More specifically, as the plunger 210 slides within the stop member 224 along the axis 236, the plunger 210 moves the follower 240, such that the follower 240 also slides within the stop member 224 along the axis 236. As the plunger 210 and the follower 240 slide along the axis 236, the follower 240 contacts the locking member 252, and more specifically the head portion 260 of the locking member 252. The follower 240 thus slides (or translates) the locking member 252, compressing the biasing member 264. The locking member 252 is pushed (by the plunger 210 and the follower 240) through the aperture 60 and into the channel 20, where it is received by the aperture 5 that extends through the mounting member 4 (shown in FIG. 2).

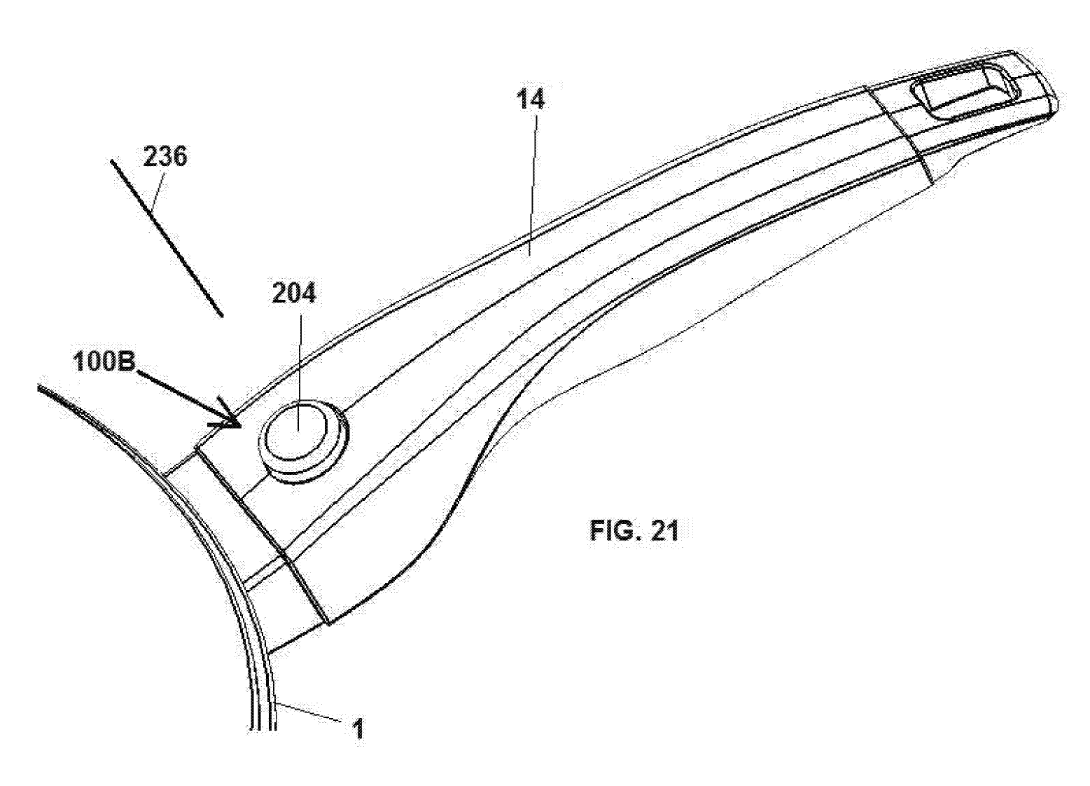

FIG. 21 illustrates the push button 204 when it is fully depressed. In this position, the plunger 210 and follower 240 slide within the stop member 224, sliding the locking member 252 into engagement with the mounting member 4. More specifically, the locking member 252 is received by the aperture 5 of the mounting member 4. Once the push button 204 is fully depressed, the user removes further downward force on the push button 204, allowing the biasing member 264 to apply a biasing force on the push button 204. The biasing force is applied through the locking member 252, which is in contact with the follower 240, which is in turn in contact with the plunger 210, the plunger 210 being in contact with the push button 204. As the biasing member 264 applies the biasing force on the locking member 252, the follower 240 and the plunger 210 slide along the axis 236 towards the push button 204. During this sliding (or translational) movement, the follower 240 also rotates about the axis 236. The rotation is generated by the plunger 210, and more specifically by each radial tooth 220 sliding along the respective sloped end 248 of the projection 244. As the follower 240 rotates, the projections 244 on the follower 240 come into contact with the ribs 232 inside the stop member 224. Once in contact, the ribs 232 restrict further sliding movement of the follower 240, maintaining the follower 240 in a partially extended (or not fully retracted position). Thus, the follower 240 maintains the position of the locking member 252 in the aperture 5 of the mounting member 4.

To disengage the locking member 252 from the mounting member 4 (e.g., to remove the locking member 252 from the aperture 5), the user repeats the steps 404 and 412. However, during step 412, when the user fully depresses the push button 204, the locking member 252 can extend into the recess 24 provided proximate the channel 20, as shown in FIG. 19. This accounts for additional lateral or sliding travel of the locking member 252 in certain embodiments of the locking assembly 100. In addition, in response to the user removing further downward force on the push button 204, the biasing member 264 applies the biasing force on the locking member 252, which slides the follower 240, the plunger 210, and the push button 204 away from the channel 20. As the follower 240 slides, it rotates out of engagement with the ribs 232, allowing the follower 240 to slide further towards the push button 204 (or further away from the channel 20). This additional sliding movement of the follower 240 allows for the locking member 252 to be fully withdrawn (or retracted) from the aperture 5 of the mounting member 4, and further retracted from the channel 20, as shown in FIG. 19. This allows the handle 14 to be removed from the cookware 1, as the mounting member 4 can freely be removed from the channel 20 in the handle 14.

Various features and advantages of the invention are set forth herein and in the following claims.

What is claimed is:

1. A detachable handle assembly for cookware, comprising:
a handle configured to removably engage a portion of the cookware; and
a locking assembly carried by the handle, the locking assembly including:
a push button operably connected to a locking member, the locking member configured to selectively engage the portion of the cookware in response to actuation of the push button.

2. The detachable handle assembly of claim 1, the locking assembly further comprising a locking collar operable between a locked position and an unlocked position, wherein the locking collar is configured to restrict actuation of the push button in the locked position and allow actuation of the push button in the unlocked position.

3. The detachable handle assembly of claim 2, wherein a biasing member biases the locking collar toward the locked position.

4. The detachable handle assembly of claim 1, wherein the push button actuates in a direction parallel to a direction of travel of the locking member.

5. The detachable handle assembly of claim 2, wherein the push button further comprises a first channel and a second channel approximately perpendicular to the first channel, and the locking collar includes a projection that is configured to slide in the first and second channels.

6. The detachable handle assembly of claim 5, wherein:
the push button is operable between a first position and a second position; and
the locking member is configured to engage the portion of the cookware in response to the push button being in the second position.

7. The detachable handle assembly of claim 6, wherein in response to actuation of the push button between the first and second position, the projection slides within the first channel, and in response to actuation of the locking collar between the locked position and the unlocked position, the projection slides within the second channel.

8. The detachable handle assembly of claim 7, wherein the locking member is biased toward a retracted position.

9. A detachable handle assembly for cookware, comprising:
a handle configured to removably engage a portion of the cookware;
a first locking subassembly carried by the handle and configured to selectively engage the portion of the cookware in response to actuation of a portion of the first locking assembly; and
a second locking subassembly carried by the handle and configured to restrict actuation of the first locking assembly.

10. The detachable handle assembly of claim 9, further comprising a locking member configured to selectively engage the portion of the cookware in response to actuation of the portion of the first locking subassembly.

11. The detachable handle assembly of claim 10, wherein the portion of the first locking subassembly is a push button.

12. The detachable handle assembly of claim 9, wherein the second locking subassembly is operable between a first position and a second position, the second locking subassembly being configured to restrict actuation of the first locking subassembly in the first position, and to allow actuation of the first locking subassembly in the second position.

13. The detachable handle assembly of claim 12, further comprising a biasing member that biases the second locking subassembly towards the first position.

14. The detachable handle assembly of claim 12, wherein the first locking sub assembly further comprising:
a first channel; and
a second channel approximately perpendicular to the first channel, the first and second channels configured to slidably receive a portion of the second locking sub assembly.

15. The detachable handle assembly of claim 14, wherein the portion of the second locking sub assembly includes a projection.

16. A method of selectively attaching a handle to an article of cookware comprising:
positioning the handle into engagement with a portion of the cookware; and
engaging a locking member to the portion of the cookware in response to actuating a push button.

17. The method of claim 16, the positioning step further comprising positioning the handle into engagement with the portion of the cookware such that the handle receives the portion of the cookware.

18. The method of claim 16, further comprising actuating a locking collar to an unlocked position before the engaging step, the locking collar being in operable communication with the push button.

19. The method of claim 18, further comprising actuating the locking collar to a locked position by a biasing member to restrict actuation of the push button after the engaging step.

20. The method of claim 18, further comprising moving the locking collar to a locked position after the engaging step to restrict actuation of the push button.
